(19) United States
(12) Patent Application Publication
(10) Pub. No.: US 2010/0192767 A1
(43) Pub. Date: Aug. 5, 2010

(54) METHOD FOR MOUNTING A FASTENER SCREW ON A BRAKE CYLINDER

(76) Inventors: Oliver Brandt, Braunschweig (DE); Jürgen Ewald, Laatzen (DE); Wilfried Mathias, Bad Nenndorf (DE); Frank Schrader, Isernhagen (DE); Oktawian Szuberski, Wroclaw (PL)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/452,886

(22) PCT Filed: Jun. 30, 2008
(86) PCT No.: PCT/EP2008/005337

§ 371 Date: Apr. 13, 2010

(30) Foreign Application Priority Data
Aug. 3, 2007 (DE) 102007036778.5
Aug. 20, 2007 (DE) 102007039204.6

(51) Int. Cl. B60T 17/08; B23P 11/00; F16J 10/02

(52) U.S. Cl. 92/169.1; 29/505

(57) ABSTRACT

The invention relates to a method for mounting a fastener screw (2, 3) on the base (5) of a brake cylinder (1). The method comprises the following steps: first, producing bores (8) in the base (5) of the brake cylinder (1) that have a smaller diameter than the diameter of the fastener screw (2, 3). Subsequently, the bore (8) is widened using a stamping tool (9) far enough that the fastener screw (2, 3) will fit through said bore, forming a collar (11). Finally, the collar (11) is reformed onto the fastener screw (2, 3) by a pressing process, whereby said collar engages in a groove (12) or a ribbing (15) of the fastener screw (2, 3), thus securing said screw.

The present invention relates generally to a new method for mounting a fastener screw on the bottom of a brake cylinder, according to the preamble of Patent Claim 1, and also to a brake cylinder produced by means of the method.

Brake cylinders must, as is known, be fastened securely to the axle of a vehicle so that force can be exerted on the actual brake. This purpose is served generally by screws that are fastened to and project out of the bottom of the brake cylinder. With the aid of these screws and corresponding nuts, the brake cylinder is screwed to part of the axle, for example a fastening plate. On account of the high forces occurring during brake actuation, the screw connection must satisfy stringent mechanical requirements.

As is known, for example, from DE 34 04 014 A1, the bottom of a brake cylinder has a plurality of holes for fastener screws. The screws are inserted through these holes from inside and project outward. So that the screws become captive, they are welded from inside to the bottom of the brake cylinder. For further securing against twisting, the screw heads are formed asymmetrically. The known welding is a relatively complicated process that increases the cost of the brake cylinder as a mass-produced component.

The object on which the present invention is based, therefore, is to specify a method for mounting the fastener screws, which satisfies the abovementioned mechanical requirements, but is less costly.

This object is achieved by means of the method embodiment specified in Patent Claim 1. The dependent claims recite advantageous additional features.

By virtue of the method according to embodiments of the present invention with forming (widening) and reforming of the fastening bores, the complicated welding operation otherwise necessary can be dispensed with entirely.

The method according to embodiments of the present invention is explained in more detail below with reference to drawings in which:

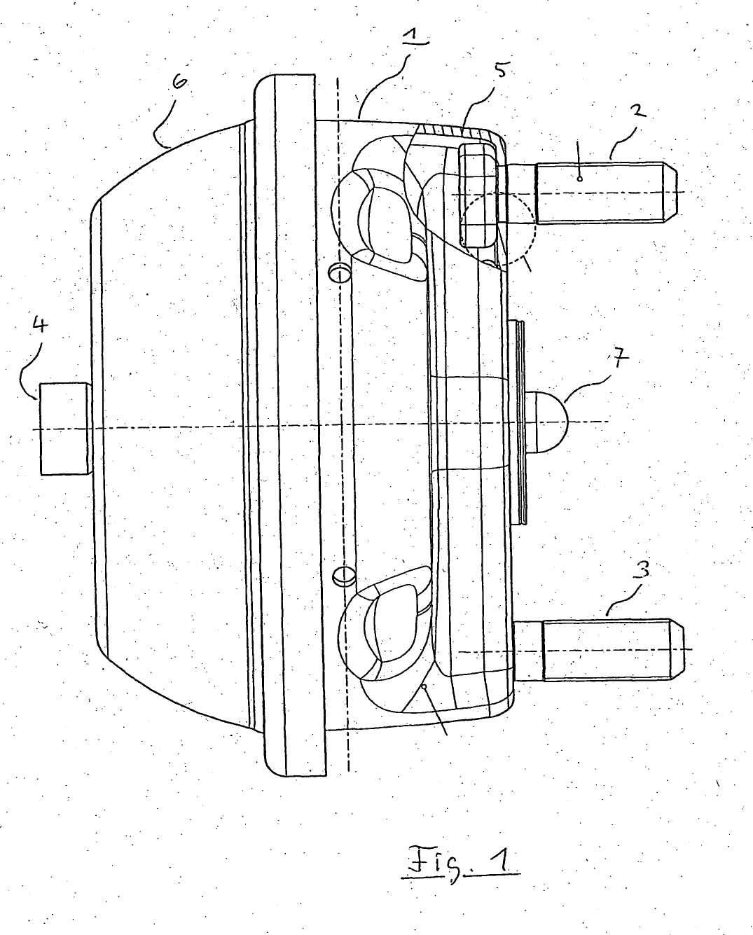

FIG. 1 shows an overall view of a brake cylinder with screws fastened according to an embodiment of the present invention, in cross section;

FIG. 2 shows a fastener screw in section with an integrally formed slot;

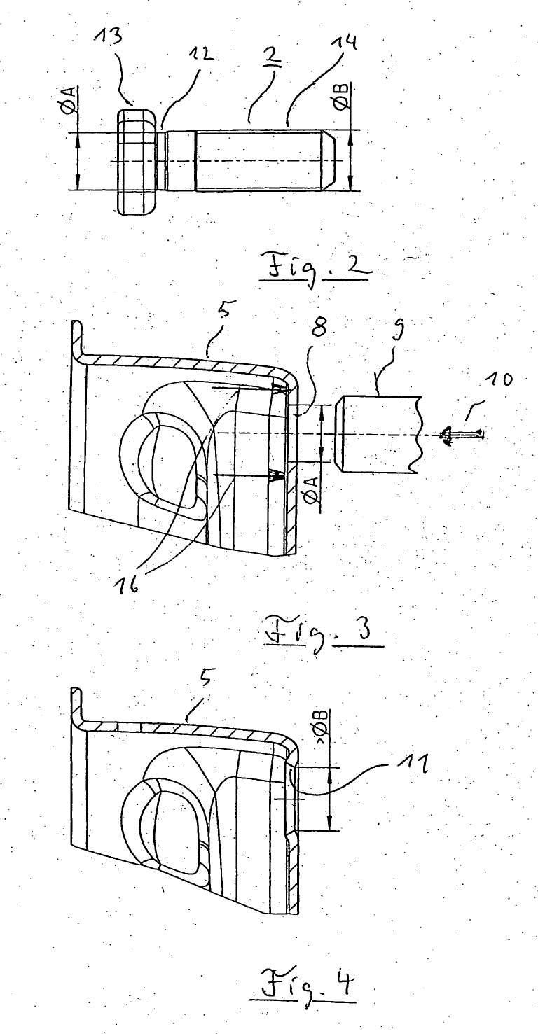

FIG. 3 shows the bottom of the brake cylinder with an adjacent external stamping tool;

FIG. 4 shows the bottom of the brake cylinder with an inwardly widened bore;

FIG. 5 shows a fastener screw inserted from inside through the widened bore;

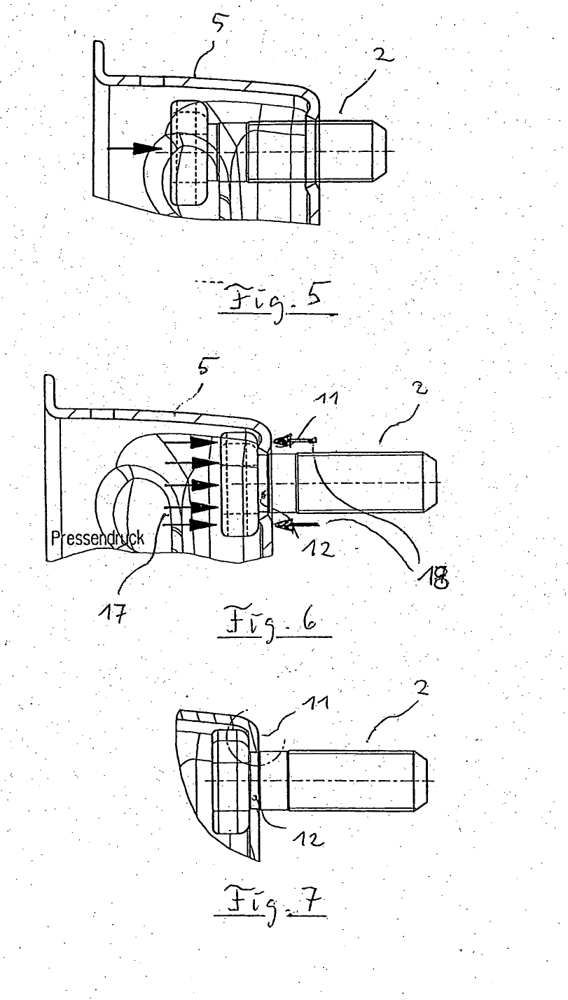

FIG. 6 shows an operation of reforming by means of pressure on the head of the fastener screw;

FIG. 7 shows the firmly seated fastener screw with a reformed collar;

FIG. 8 shows a fastener screw with integrally formed grooved region;

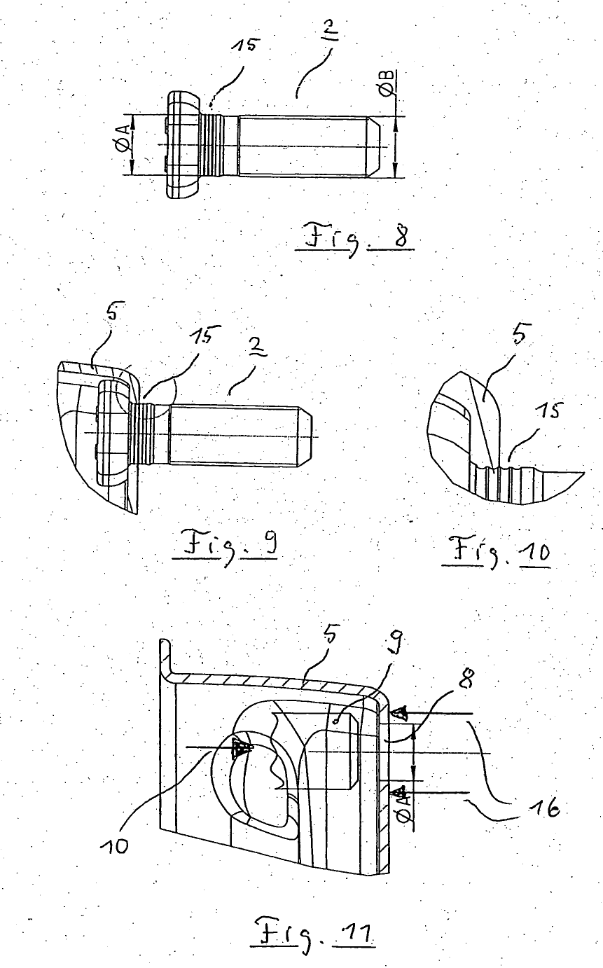

FIG. 9 shows the firmly seated fastener screw with a reformed collar;

FIG. 10 shows a detail from FIG. 9 in the region of the grooving;

FIG. 11 shows the bottom of the brake cylinder with an adjacent internal stamping tool;

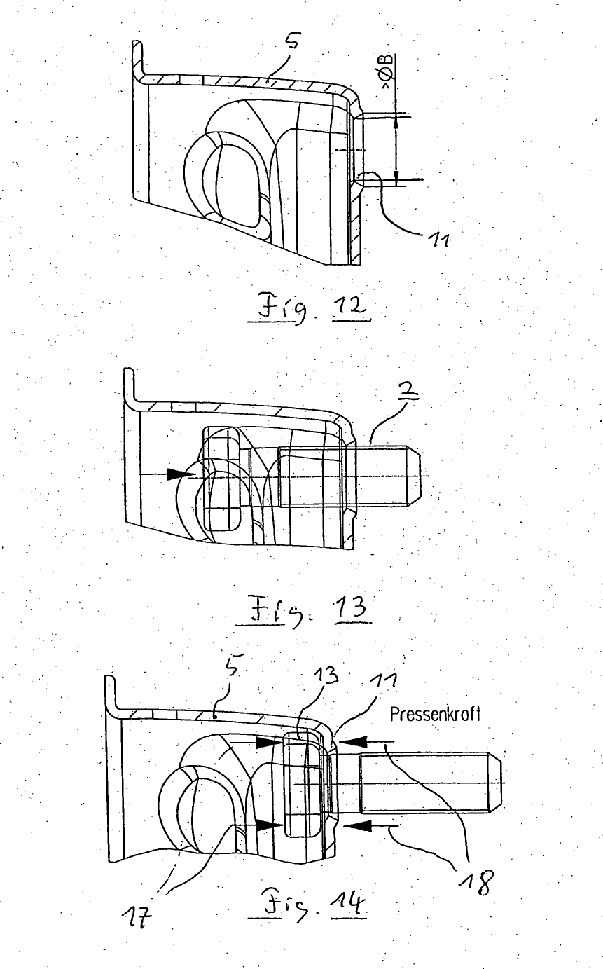

FIG. 12 shows the bottom of the brake cylinder with an outwardly widened bore;

FIG. 13 shows a fastener screw inserted from inside through the widened bore; and

FIG. 14 shows the operation of reforming by means of pressure on the collar.

FIG. 1 illustrates a brake cylinder (1) with two fastener screws (2, 3) fastened by the method according to an embodiment of the present invention. The brake cylinder (1) includes two parts fastened to one another, namely, a bottom (5) and a cover (6). The cover (6) has a connection (4) for introducing the actuating medium, for example compressed air. When the brake cylinder (1) is being filled with the actuating medium, a piston rod (7) for actuating the actual brake (not illustrated) is moved out. The piston rod (7) is connected, for this purpose, to a piston (not illustrated) inside the brake cylinder (1).

FIG. 2 illustrates one of the fastener screws (2, 3) in more detail. It consists, as is customary, of a head (13) and of a threaded part (14). A slot (12) is integrally formed into the threaded part (14) adjacent to the head (13). The threaded part (14) has a diameter B. The slot (12) has a diameter A, which is smaller than the diameter B.

FIG. 3 shows the bottom (5) of the brake cylinder (1), which is provided in a known manner with bores (8). Two bores may be present or else there may even be further bores distributed annularly on the bottom of the brake cylinder (5).

The bore (8) expediently has the diameter A, that is, the same diameter as the slot (12) of the screw (2). However, a smaller diameter than A may also be used for the bores (8).

In accordance with an embodiment of the inventive method, the bore (8) is first widened by means of a stamping tool (9) that is pressed onto the bore (8) from outside in the direction of an arrow (10) and that is shaped conically at the front. In this case, the brake cylinder can be held from inside by an annular holding tool (not illustrated) that exerts a force on the circumference of the bore (8) in the direction of the arrows (16).

As can be seen in FIG. 4, in this case, an inwardly projecting collar (11) is produced, the diameter of which must be such that the screw (2) fits through it with the threaded part (14). The diameter of the collar (11) is therefore larger than the diameter B of the threaded part (14) of the screw (2).

In a next step (FIG. 5), the screw (2) is inserted from inside through the widened bore (8).

In a next step (FIG. 6), the screw head (13) of the inserted fastener screw (2) is pressed from inside by means of a press against the collar (11), and the latter is consequently reformed. The press pressure in this case acts on the screw head (13) in the direction of the arrows (17). The margin of the bore (8) is thereby pressed completely into the slot (12), with the result that a diameter A of the bore (8) is established. In this case, the bottom (5) of the brake cylinder (1) can be held in the region of the bore (8) by an annular holding tool (not illustrated) that engages from outside and that applies a force in the direction of the arrows (18).

As shown in FIG. 7, which illustrates a final state of the method according to an embodiment of the present invention, the collar (11) is pressed into the slot (12) of the screw (2) and therefore retains the latter captively.

FIG. 8 shows a variant of the fastener screw (2). Instead of a slot (12), a grooved region (15) is provided. The grooves in this case extend annularly around the screw body. However, they may also be formed differently, for example diagonally. The screw (2) has the diameter A in the grooved region.

As shown in FIG. 9, the margin of the bore (8) engages into the grooved region (15) after reforming, with the result that the screw is likewise held captively.

FIG. 10 illustrates more precisely how the grooved screw (2) is in this case integrally formed into the margin of the bore (8). In this case, the material of the screw (2) is harder than that of the brake cylinder bottom (5).

FIGS. 11 to 14 show a variant of the inventive method, whereby the stamping tool (9) does not engage from the inside, but, instead, from the outside.

FIG. 11 shows the brake cylinder bottom (5) with a stamping tool (9), which is pressed from inside with a force in the direction of the arrow (10) against the brake cylinder bottom (5) having the bore (8). In this case, the bottom (5) is held from outside by an annular holding tool (not illustrated) that exerts a force in the direction of the arrows (16) on the bottom (5) in the region of the bore (8). The initial diameter of the bore (8) is in this case equal to A or smaller than A.

FIG. 12 shows how a collar (11) has been formed, this time outwardly, by the force of the stamping tool (9). The diameter of the bore (8) has thereby been widened to a diameter larger than the diameter B of the threaded part (14) of the screw (2).

In a next step, shown in FIG. 13, the screw (2) is inserted from inside through the widened bore (8) correspondingly to FIG. 5.

As a next step (FIG. 14), a force is applied to the screw head (13) from inside in the direction of the arrows (17). The bottom (5) can be held in the region of the bore (8) by an annular holding tool (not illustrated) in the direction of the arrows (18).

In this case, the previously outward-projecting collar (11) is reformed inwardly. The final state is a firmly seated screw according to FIG. 7 or FIG. 1.

The operation of stamping the brake cylinder bottom (5) may take place individually or else jointly for all bores (8).

To make the bottom (5) watertight, the brake cylinder (1) may subsequently be lacquered. The lacquer in this case penetrates into a gap possibly still remaining between the slot (12) or grooving (15) and the collar (11) and consequently additionally seals this off. The vehicle equipped with the brake cylinder (1) can thereby be made fordable. The threaded part (14) of the fastener screws (2, 3) should be covered during the lacquering operation.

In order to prevent the fastener screws (2, 3) from twisting when the brake cylinder (1) is being screwed on, the head (13) of the screws may in a known way be additionally produced asymmetrically (not illustrated). As a result, by the asymmetric screw head (12) coming to bear against the inner wall of the bottom (5) of the cylinder (1), a form fit and, consequently, protection of the screws against twisting are ensured (see DE 34 04 014 A1).

Accordingly, by means of the embodiments of the method according to the present invention, fastener screws of brake cylinders can be fastened reliably and cost-effectively.

1. A method for mounting a fastener screw (2, 3) on the bottom (5) of a brake cylinder (1), characterized by the following steps:
a) production of bores (8) in the bottom (5) of the brake cylinder (1) with a diameter (A) smaller than the thread diameter (B) of the fastener screws (2, 3);
b) widening of the bores (8) by means of a stamping tool (9) to a diameter larger than (B) so as to produce a formed collar (11);
c) insertion of the fastener screws (2, 3) into the widened bores (8); and
d) pressing operation with reforming of the collar (11) such that the latter comes to bear against the fastener screws (2, 3).

2. The method according to claim 1, characterized in that the bores (8) are widened inwardly, so as to produce an inwardly formed collar (11), by means of a stamping tool (9) engaging from outside.

3. The method according to claim 1, characterized in that the bores (8) are widened outwardly, so as to produce an outwardly formed collar (11), by means of a stamping tool (9) engaging from inside.

4. The method according to claim 1, characterized in that a lacquering of the brake cylinder (1) to achieve water tightness in the region of the fastener screws (2, 3) is carried out.

5. A brake cylinder (1) with fastener screws (2, 3), which is produced, using the method according to claim 1.

6. The brake cylinder according to claim 5, characterized in that it has fastener screws (2, 3) that are held by means of a reformed collar (11) that engages a slot (12) of the fastener screws (2, 3).

7. The brake cylinder according to claim 5, characterized in that it has fastener screws (2, 3) that are held by means of a reformed collar (11) that engages a grooved region (15) of the fastener screws (2, 3).
